(19) United States
(12) Patent Application Publication
(10) Pub. No.: US 2024/0251778 A1
(43) Pub. Date: Aug. 1, 2024

(54) FOGGING MACHINE

(71) Applicant: TMK Designs, LLC, San Diego, CA (US)

(72) Inventor: Lawrence C. NORA, San Diego, CA (US)

(21) Appl. No.: 18/420,928

(22) Filed: Jan. 24, 2024

Related U.S. Application Data
(60) Provisional application No. 63/441,411, filed on Jan. 26, 2023.

(51) Int. Cl. A01M 13/00

(52) U.S. Cl. CPC A01M 13/00

(57) ABSTRACT

A fogging machine includes a blower assembly that includes an electric motor and a turbine coupled to the electric motor and configured to generate an airflow. A conduit is connected to the blower assembly and terminates at a conduit outlet. The conduit is configured to permit an operator to direct the airflow at a desired location. A liquid assembly is connected to the blower assembly for emitting a liquid in the airflow to create a mist. A support assembly permits the fogging machine to be carried by an operator.

### CROSS-REFERENCE TO RELATED APPLICATIONS

This utility patent application claims the benefit of and priority to U.S. provisional patent application Ser. No. 63/441,411, filed on Jan. 26, 2023, the entire disclosure of which is hereby incorporated by reference in their entireties

### TECHNICAL FIELD

The present disclosure generally relates to a fogging machine. More particularly, the present disclosure relates to a portable fogging machine for emitting a mist such as a pesticide.

### BACKGROUND

Fogging machines, or mist blowers, are commonly used for emitting mists, such as pesticide chemicals for addressing pest control or other needs. Fogging machines typically include a combustion engine for creating an airflow in a conduit that is controllable by an operator. A liquid assembly injects a chemical in a path of the airflow for creating a mist at the target. An issue with conventional fogging machines is they can be loud, making them disruptive especially in populated areas like residential and commercial settings. Additionally, fogging machines with combustion engines emit carbon monoxide, which makes them dangerous for fogging in indoor settings. Accordingly, there is a need for improvements to fogging machines.

### SUMMARY OF THE INVENTION

According to an aspect of the disclosure, a fogging machine includes a blower assembly that includes an electric motor and a turbine coupled to the electric motor and configured to generate an airflow. A conduit is connected to the blower assembly and terminates at a conduit outlet. The conduit is configured to permit an operator to direct the airflow at a desired location. A liquid assembly is connected to the blower assembly for emitting a liquid in the airflow to create a mist. A support assembly permits the fogging machine to be carried by an operator.

According to another aspect of the disclosure, a fogging machine includes a blower assembly that has a housing containing a motor and a turbine coupled to the motor and configured to generate an airflow. A conduit is connected to the blower assembly and terminates at a conduit outlet for emitting the airflow. A tank is connected to the housing for containing a liquid. A nozzle is positioned adjacent to the conduit outlet for emitting the liquid into airflow. A hose fluidly connects the tank to the nozzle. A support assembly is connected to the housing for permitting the fogging machine to be carried by an operator. The motor is an electric motor.

According to another aspect of the disclosure, a method of fogging an indoor space includes providing a fogging machine that includes a blower assembly with a motor and a turbine coupled to the motor and configured to generate an airflow, a conduit connected to the blower assembly and terminating at a conduit outlet for emitting the airflow, a liquid assembly connected to the blower assembly for emitting a liquid in the airflow to create a mist, and a support assembly for permitting the fogging machine to be carried by an operator. The motor is an electric motor. The method also includes emitting the mist in the indoor space.

The use of an electric motor in the subject fogging machine advantageously provides a low noise/decimal level during use, which makes the fogging machine ideal for spraying in high population density areas like residential and commercial locations. Furthermore, the electric motor renders the fogging machine emission free, thus making it useable in indoor settings because it meets emission standards.

### BRIEF DESCRIPTION OF THE DRAWINGS

Other aspects of the present invention will be readily appreciated, as the same becomes better understood by reference to the following detailed description when considered in connection with the accompanying drawings wherein:

FIG. 1 is a side view of an embodiment of a fogging machine according to an aspect of the disclosure;

FIG. 2 is a rear, perspective view of the fogging machine;

FIG. 3 is a rear view of the fogging machine;

FIG. 4 is a rear, magnified view of the fogging machine, illustrating a door for opening and closing an opening for receiving a rechargeable battery;

FIG. 5 is a perspective view of a throttle handle of the fogging machine; and

FIG. 6 is a flow diagram of a method of fogging a space with the fogging machine.

### DESCRIPTION OF THE EXAMPLE EMBODIMENT

In the following description, details are set forth to provide an understanding of the present disclosure. In some instances, certain systems, structures and techniques have not been described or shown in detail in order not to obscure the disclosure.

Referring to the figures, wherein like numerals indicate corresponding parts throughout the several views, example embodiments of a fogging machine 10 are provided. The fogging machine 10 may be used for various purposes, including the emission of pesticides or other chemicals. The fogging machine 10 generally includes a blower assembly 12 for generating an airflow out of a conduit 34, a liquid assembly 48 for injecting a liquid into the airflow for creating a mist, and a support assembly 68 for permitting an operator to hold and control the fogging machine in a convenient manner.

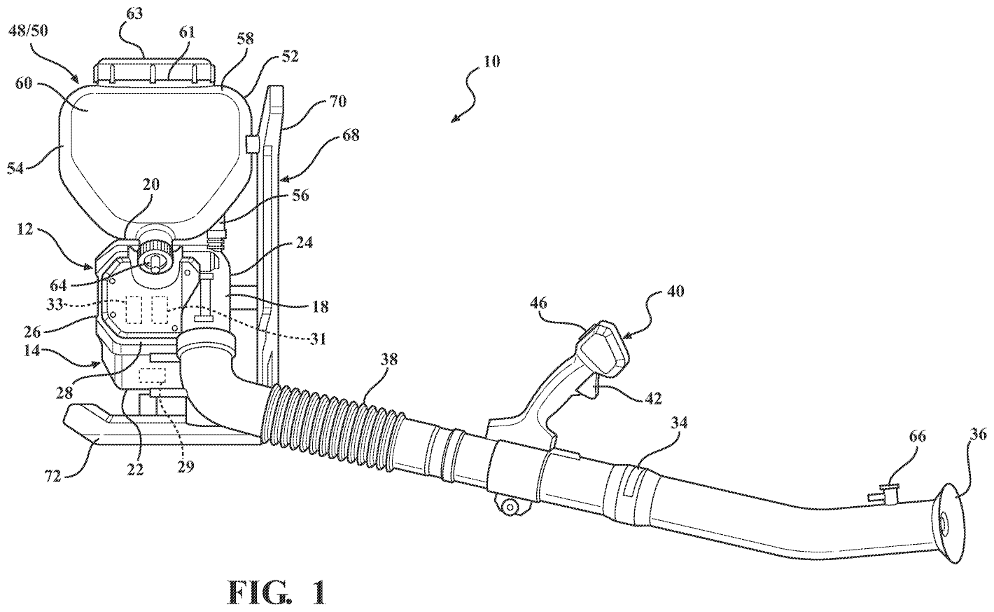

The blower assembly 12 has a housing 14 that defines a compartment for holding components of the blower assembly 12. It should be appreciated that the compartment may be divided/separated into several sub-compartments for holding specific component. The sub-compartments may be fluidly separated from one another such that pressurized air, oil, water, etc. isn't able to pass between sub-compartments. The housing 14 has a top face 20, a bottom face 22, a front face 24, a rear face 26 and a pair of side faces 28. The front face 24 of the housing 14 defines a blower outlet 18 for emitting the airflow. A motor 29 (schematically shown in FIG. 1) is disposed in the compartment. The motor 29 is configured to rotate a motor output. The blower assembly 12 further includes a turbine/fan 31 (schematically shown) located in the compartment that is configured to rotate with the output of the motor 29 to generate the outflow of air. The blower assembly 12 may also include a gear reduction device located in the compartment between the motor output and turbine 31 in order to provide a gear reduction between the motor 29 and the turbine 31 as needed.

The motor 29 is an electric motor, which advantageously provides a low noise/decimal level during use, which makes the fogging machine ideal for spraying in high population density areas like residential and commercial locations. Furthermore, because of the use of an electric motor 29, the fogging machine is emission free, thus making it useable in indoor settings by meeting emission standards.

The blower assembly 12 further includes a battery 33 (schematically shown) that is located in the compartment and is electrically connected to the motor 29 for powering the motor 29. According to the preferred embodiment, the battery 33 is a lithium ion battery that is both water and corrosion resistant and designed to get wet without incurring damage. Also according to the preferred embodiment, the battery is a 36v 7.5 amp or 9 amp hr lithium ion battery. Other batteries may be used without departing from the scope of the present disclosure.

As best illustrated in FIG. 4, one of the side faces 28 of the housing 14 defines a battery opening 30 for receiving the battery 33. A door 32 is pivotally connected to the at least one side face 28 for opening and closing the battery opening 30. A latch 33 is provided for locking the door 32 in a closed position. The arrangement of the battery opening 30 and door 32 permits the battery 33 to easily be swapped with other batteries and/or removed for charging. Furthermore, positioning the battery 33 inside the compartment prevents damage to the battery 33 from the ambient environment, especially from chemicals used in the liquid assembly 48. The door 32 and other housing 14 components may be of lightweight plastic materials that are resistant to liquids to ensure that internal components remain dry.

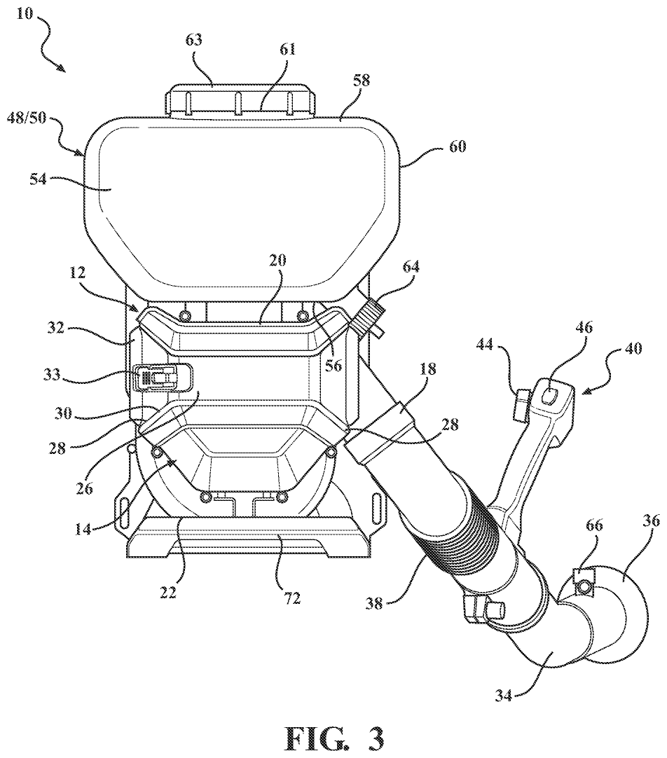

With reference back to FIGS. 1-3, the conduit 34 is connected to the blower output 18 of the blower assembly 12 and terminates at a conduit outlet 36 through which the generated airflow passes. As shown, a sleeve style fit may be used to connect the blower output 18 and conduit 36, but other connection mechanisms may be used without departing from the scope of the subject disclosure. The conduit 34 includes a bellows 38 adjacent to the housing 14 to permit the conduit 34 to be bent such that it may be directed at desired locations by an operator.

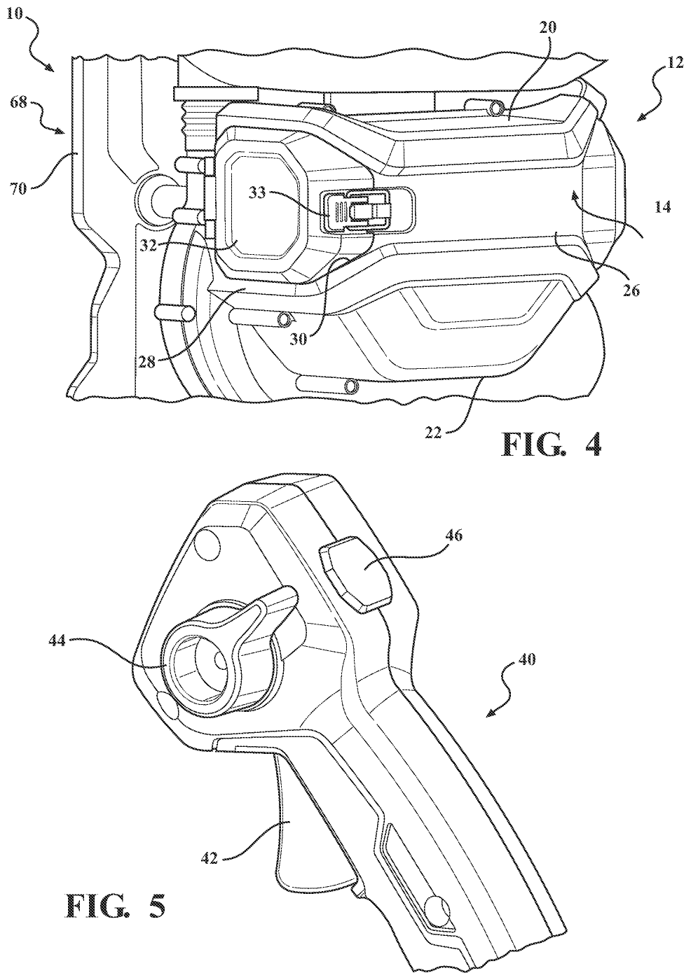

As best shown in FIG. 5, a throttle handle 40 is connected to the conduit and is in communication with the motor 29 for adjusting a speed of airflow out of the conduit 34. The throttle handle 40 includes a trigger 42 for allowing an operator to instantly adjust a speed of the airflow. The throttle handle 40 also includes a lock dial 44 for locking various speeds of airflow, and a kill switch 46 for turning off the motor 29.

As best shown in FIGS. 1-3, the liquid assembly 48 is connected to the blower assembly 12 for emitting a liquid in the airflow to create a mist. The liquid assembly 48 includes a tank 50 connected to the top face of the housing 14. The tank 50 has a front face 52, a rear face 54, a lower face 56, a top face 58 and a pair of side faces 60. The top face 58 of the tank 50 defines a port 61 for receiving the liquid. A cap 63 removeably closes the port 60 for sealing the tank 50. The tank 50 further defines a tank outlet 64 along a meeting of the lower face 56 and one of the side faces 60. The tank outlet 64 and port 61 could be positioned at other locations on the tank 50 without departing from the scope of the subject disclosure.

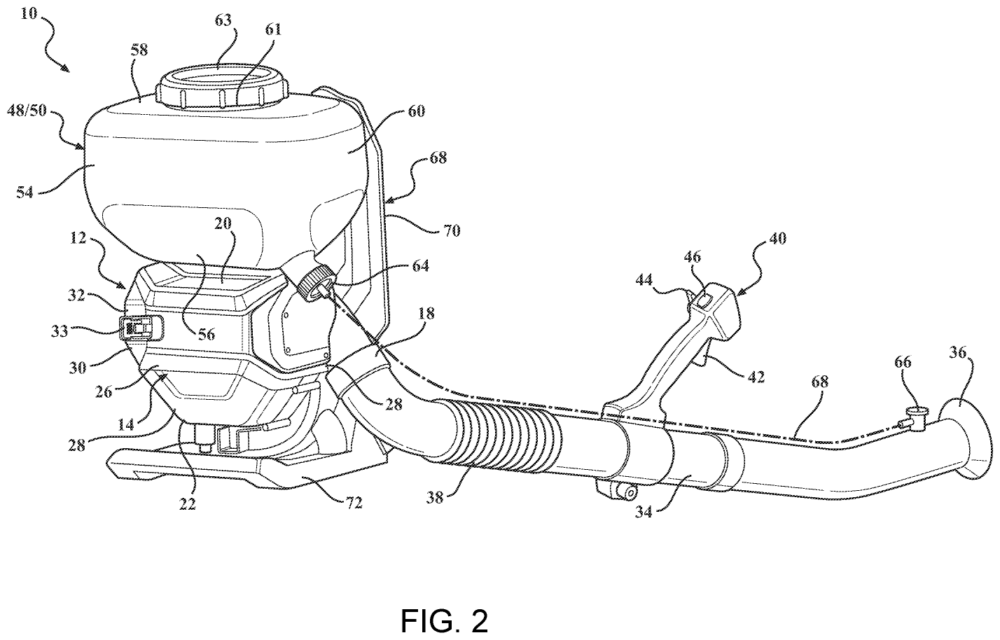

The liquid assembly 48 further includes a nozzle 66 adjacent to the conduit outlet 36 of the conduit 34 for emitting the liquid into the outflow of air for creating a mist. A hose 68 (schematically shown in FIG. 2) fluidly connects the tank outlet 64 of the tank 50 and the nozzle 66 for transporting the liquid from the tank 50 to the nozzle 66. The nozzle 66 is located such that the airflow from the conduit 34 displaces the liquid evenly and effectively to create a mist.

The support assembly 68 permits the fogging machine 10 to be worn by an operator. The support assembly 68 includes a back support 70 connected to the front face 24 of the housing 14 and the forward face of the tank 52 of the liquid assembly 48 for supporting the fogging machine 10 along the operator's back during use. The support assembly 68 may further include one or more straps or other connecting devices connected to the back support 70 or other components of the fogging machine 10 for securing the back support 70 to the operator. A support base 72 is coupled with the bottom face 22 of the housing 14 and configured to support the fogging machine 10 on a supporting surface like the ground while not in use.

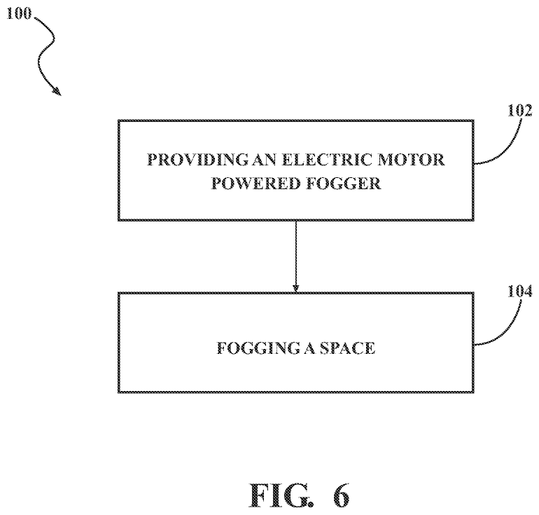

As set forth in FIG. 6, a method 100 of fogging a space is also provided. The method 100 includes 102 providing an electric motor powered fogging machine 10 in accordance with the above. The method also includes 104 fogging the space with the fogging machine 10. According to embodiments, the space is a congested area and/or an indoor space such that the benefits of an emission free and quiet electric motor powered fogger 10 discussed above are realized.

Obviously, many modifications and variations of the present invention are possible in light of the above teachings and may be practiced otherwise than as specifically described while within the scope of the appended claims. Individual elements or features of a particular embodiment are generally not limited to that particular embodiment, but, where applicable, are interchangeable and can be used in a selected embodiment, even if not specifically shown or described.

What is claimed is:

1. A fogging machine, comprising:
a blower assembly including a motor and a turbine coupled to the motor and configured to generate an airflow;
a conduit connected to the blower assembly and terminating at a conduit outlet for emitting the airflow,
a liquid assembly connected to the blower assembly for emitting a liquid in the airflow to create a mist; and
a support assembly for permitting the fogging machine to be carried by an operator;
wherein the motor is an electric motor.

2. The fogging machine as set forth in claim 1, further including a battery electrically connected to the motor for powering the motor.

3. The fogging machine as set forth in claim 2, wherein the battery is a lithium ion battery.

4. The fogging machine as set forth in claim 2 further including a housing containing the motor, turbine and battery.

5. The fogging machine as set forth in claim 4 wherein the housing has a top face, a bottom face, a front face, a rear face and a pair of side face.

6. The fogging machine as set forth in claim 5, wherein the conduit extends from the front face of the housing, and wherein a back support is connected to the front face for engaging a back of a user during use.

7. The fogging machine as set forth in claim 6, wherein the liquid assembly includes a tank connected to the top face of the housing for containing the liquid.

8. The fogging machine as set forth in claim 7, wherein the tank has a front face, a rear face, a lower face, a top face and a pair of side face, and wherein the tank defines a tank outlet along the lower face.

9. The fogging machine as set forth in claim 8, wherein a nozzle is positioned adjacent to the outlet of the conduit for emitting the liquid into the airflow, and wherein a hose extends between the tank outlet and the nozzle.

10. The fogging machine as set forth in claim 8, wherein the back support is further connected to the forward face of the tank.

11. The fogging machine as set forth in claim 8, wherein the top face of the tank defines a port for receiving the liquid, and wherein a cap removably closes the port.

12. The fogging machine as set forth in claim 7, wherein the liquid includes a pesticide contained in the tank.

13. The fogging machine as set forth in claim 5, wherein one of the side faces defines a battery opening for receiving the battery, and wherein a door is pivotally connected to the one of the side faces for opening and closing the battery opening.

14. A fogging machine, comprising:
a blower assembly including a housing containing a motor and a turbine coupled to the motor and configured to generate an airflow;
a conduit connected to the blower assembly and terminating at a conduit outlet for emitting the airflow;
a tank connected to the housing for containing a liquid;
a nozzle positioned adjacent to the conduit outlet for emitting the liquid into airflow;
a hose fluidly connecting the tank to the nozzle; and
a support assembly connected to the housing for permitting the fogging machine to be carried by an operator;
wherein the motor is an electric motor.

15. The fogging machine as set forth in claim 14, further including a battery electrically connected to the motor for powering the motor.

16. The fogging machine as set forth in claim 15, wherein the battery is a lithium ion battery.

17. The fogging machine as set forth in claim 15, wherein the housing defines a battery opening for receiving the battery, and wherein a door is pivotally connected to the housing for opening and closing the battery opening.

18. The fogging machine as set forth in claim 14, wherein the support assembly is further connected to the tank.

19. A method of fogging an indoor space, comprising:
providing a fogging machine, comprising a blower assembly including a motor and a turbine coupled to the motor and configured to generate an airflow, a conduit connected to the blower assembly and terminating at a conduit outlet for emitting the airflow, a liquid assembly connected to the blower assembly for emitting a liquid in the airflow to create a mist, and a support assembly for permitting the fogging machine to be carried by an operator, wherein the motor is an electric motor; and
emitting the mist in the indoor space.

20. The method as set forth in claim 19, wherein the liquid is a pesticide such that the mist is a pesticide mist, and wherein emitting the mist in the indoor space includes emitting the pesticide mist.
